(19) United States
(12) Patent Application Publication
(10) Pub. No.: US 2018/0214935 A1
(43) Pub. Date: Aug. 2, 2018

(54) Ceramic Core for an Investment Casting Process

(71) Applicants: ROLLS-ROYCE plc, London (GB); ROSS CERAMICS LTD, Derby (GB)

(72) Inventors: Aleksander M. CENDROWICZ, Derby (GB); Graham J. BING, Derby (GB); Stewart T. WELCH, Birmingham (GB)

(73) Assignees: ROLLS-ROYCE plc, London (GB); ROSS CERAMICS LTD., Derby (GB)

(21) Appl. No.: 15/879,527

(22) Filed: Jan. 25, 2018

(30) Foreign Application Priority Data
Jan. 27, 2017 (GB) 1701365.7

(51) Int. Cl. B22C 9/10; B22C 9/24; B22C 7/02; B22C 9/04

(52) U.S. Cl. CPC B22C 9/108; B22C 9/24; F01D 5/187; B22C 9/04; F05D 2230/211; B22C 7/02

(57) ABSTRACT

Described is a ceramic core for producing cast component for a gas turbine engine, the core comprising: a first cavity forming member; a second member adjacent to or opposite the first cavity forming member; and a removable web which joins the first and second members.

### CROSS-REFERENCE TO RELATED APPLICATION

This application is based upon and claims the benefit of priority from British Patent Application Number 1701365.7 filed Jan. 27, 2017, the entire contents of which are incorporated by reference.

### FIELD

This disclosure relates to a ceramic core for an investment casting process. The disclosure is particularly useful for air cooled components for a gas turbine engine.

### BACKGROUND

With reference to FIG. 1, a ducted fan gas turbine engine generally indicated at 10 has a principal and rotational axis X-X. The engine comprises, in axial flow series, an air intake 11, a propulsive fan 12, an intermediate pressure compressor 13, a high-pressure compressor 14, combustion equipment 15, a high-pressure turbine 16, and intermediate pressure turbine 17, a low-pressure turbine 18 and a core engine exhaust nozzle 19. A nacelle 21 generally surrounds the engine 10 and defines the intake 11, a bypass duct 22 and a bypass exhaust nozzle 23.

The gas turbine engine 10 works in a conventional manner so that air entering the intake 11 is accelerated by the fan 12 to produce two air flows: a first air flow A into the intermediate pressure compressor 13 and a second air flow B which passes through the bypass duct 22 to provide propulsive thrust. The intermediate pressure compressor 13 compresses the air flow A directed into it before delivering that air to the high pressure compressor 14 where further compression takes place.

The compressed air exhausted from the high-pressure compressor 14 is directed into the combustion equipment 15 where it is mixed with fuel and the mixture combusted. The resultant hot combustion products then expand through, and thereby drive the high, intermediate and low-pressure turbines 16, 17, 18 before being exhausted through the nozzle 19 to provide additional propulsive thrust. The high, intermediate and low-pressure turbines respectively drive the high and intermediate pressure compressors 14, 13 and the fan 12 by suitable interconnecting shafts.

Other applicable gas turbine engines may have alternative configurations. By way of example such engines may have an alternative number of interconnecting shafts (e.g. two) and/or an alternative number of compressors and/or turbines. Further the engine may comprise a gearbox provided in the drive train from a turbine to a compressor and/or fan.

The performance of gas turbine engines, whether measured in terms of efficiency or specific output, is improved by increasing the turbine gas temperature. It is therefore desirable to operate the turbines at the highest possible temperatures. For any engine cycle compression ratio or bypass ratio, increasing the turbine entry gas temperature produces more specific thrust (e.g. engine thrust per unit of air mass flow). However as turbine entry temperatures increase, the life of an un-cooled turbine falls, necessitating the development of better materials and the introduction of internal air cooling.

In modern engines, the high-pressure turbine gas temperatures are hotter than the melting point of the material of the blades and vanes, necessitating internal air cooling of these aerofoil components. During its passage through the engine, the mean temperature of the gas stream decreases as power is extracted. Therefore, the need to cool the static and rotary parts of the engine structure decreases as the gas moves from the high-pressure stage(s), through the intermediate-pressure and low-pressure stages, and towards the exit nozzle.

FIG. 2 shows an isometric view of a typical single stage cooled turbine in which there is a nozzle guide vane in flow series with a turbine rotor. The nozzle guide vane includes an aerofoil 31 which extends radially between inner 32 and outer 33 platforms. The turbine rotor includes a blade mounted to the peripheral edge of a rotating disc. The blade includes an aerofoil 32 which extends radially outwards from an inner platform. The radially outer end of the blade includes a shroud which sits within a seal segment 35. The seal segment is a static component and attached to the engine casing. The arrows in FIG. 2 indicate cooling flows.

The main gas path extends from an upstream direction through the nozzle guide vane which accelerates and swirls the hot gas in the direction of the turbine blade rotation. The orientation of hot gas reacts with the aerodynamic shape of the turbine blades to drive the rotor, shaft and compressor (or fan as the case may be). The vanes and blades are arranged in flow series pairs throughout the turbine section of the engine.

The temperature of the gas path components, that is, aerofoils, platforms, shrouds and shroud segments etc, are primarily limited by internal convection and external films of cooling the gas path components. The internal and external cooling air is delivered by a plurality of conduits and passages which extend from the respective compressor stage to a point of delivery local to the component in question. From there, the cooling air is channelled through the air cooled component via internal passageways before being exited at a desired location. Typically, external cooling is provided via film cooling holes on the pressure surface 36, along the radial extent of the trailing edge 37, along shroud edge faces 38 and from the radial periphery of the blade 39.

The high-pressure turbine components typically receive cooling air taken from the high pressure compressor that has by-passed the combustor and is therefore relatively cool compared to the gas temperature. Typical cooling air temperatures are between 800 and 1000 K, while gas temperatures can be in excess of 2100 K.

The arrangement of cooling passages within the vanes and blades are established to provide a delivery of the cooling air to the requisite locations whilst providing internal cooling. Further, the cooling passages must be accommodated within the body of the aerofoil without compromising the resilience of the component.

The provision of internal cooling and external cooling is well known in the art and the arrangement of cooling holes and passageways has been the subject of extensive research and development for many years.

Metallic nozzle guide vanes, NGVs, turbine blades and seal segments which define the outer gas path wall are typically made from an investment casting process. Investment casting, or lost-wax casting, is a well-known manufacturing technique in which a low melting point material, such as wax, is used to produce a replica of the component to be cast. The wax part is coated with a ceramic shell before the wax is removed to leave a hollow ceramic shell for the receipt of molten metal.

A well-known adaptation to the basic investment casting process is to include a ceramic core within the wax part. The ceramic core remains within the ceramic shell once the wax has been removed and is there to provide a cavity, such as the cooling passageways, within the cast metallic part.

Investment casting is used in the aerospace industry to produce turbine blades amongst other components. Typically, a ceramic core defining internal cooling passages is provided within a wax moulding having the external shape of a turbine blade. This is then invested within a ceramic shell and the wax removed. Once the metal is cast within the shell, the ceramic core is removed from within the metal blade to leave internal cooling passages.

A typical investment casting method 310 for a turbine stage component is shown in FIG. 3. The first step involves the provision of a ceramic core 312. This is typically achieved by injecting a ceramic paste into a mould under pressure (or by pouring into moulds (slip casting) or an additive manufacture processes), the mould having the shape of the internal cavities or passages required within the cast component. The moulded ceramic is left to solidify before being fired in an oven to harden the ceramic core. Once fired, the ceramic core is placed within a second mould which has an internal shape which corresponds to the external shape of the component, e.g. a turbine blade.

A sacrificial material, molten wax for example, is injected into the second mould under pressure 314 to surround the ceramic core and provide a wax replica of the component to be cast. Because the wax is injected under pressure the ceramic core can be placed under a substantial level of stress and strain which can reposition portions of the ceramic core relative to itself and/or the mould. Hence, it is known to carry out one or more intermediary steps to strengthen the core so that it can withstand the thermal and mechanical shock induced by the injection of the wax. Such a process may include the bulk application of wax to bridge adjacent portions of the core to bind them together and provide some additional rigidity. Such portions may, for example, be the adjacent sections of a serpentine core which provide internal flow passages in the final cast product. Using the same binding material as is used for the sacrificial material is advantageous due to it being inherently compatible.

Another approach to binding neighbouring core passages is to provide core ties or bumpers which extend between the core passages locking them together and preventing subsequent movement. Such core ties may be part of the core itself as shown in U.S. Pat. No. 5,296,308, or may be provided by metallic inserts which bridge between the adjacent cores, such as platinum pins. The use of integral ceramic core ties is problematic due to the creation unwanted holes through the dividing walls of the passageways which represent a superfluous and potentially deleterious cooling flow. The use of metallic core ties negates this problem by melting and becoming subsumed in the passage wall. However, the presence of the integral metal plug can negatively affect the alloy used to cast the blade.

Once the molten wax has been injected and solidified, the composite wax core consisting of the ceramic core and wax outer, is removed from the second mould and repeatedly dipped in ceramic slurry and stucco to provide a layered shell suitable for receiving the molten metal within 316. The ceramic shell is dried and the wax removed 318 using an appropriate method. This may involve heating the wax, or using a suitable solution to dissolve it. The solution may be water used in a steam autoclave, or firing at high temperature.

The ceramic shell is fired prior to the introduction of molten metal and casting of the part 320. Once solidified, the ceramic shell is removed from the outer of the metallic part, typically mechanically and the inner ceramic core is leached out using an appropriate solution 322.

Despite the processes involved in conventional investment casting being reasonably well understood, failures still occur and a good deal of time and effort is required to tailor the design of the cast parts and ceramic cores to increase the yield ratio from a given process line. The present disclosure seeks to provide an improved ceramic core and method of producing a cast component which may lead to higher yield ratios.

### BRIEF SUMMARY

The present disclosure provides a ceramic core, a production facility and a method of creating a ceramic core for a casting process according to the appended claims.

Below there is described a ceramic core for producing cast component for a gas turbine engine, the core comprising: a first cavity forming member; a second member adjacent to or opposite the first cavity forming member; and a removable web which joins the first and second members.

Providing a removable web between two of the members of a ceramic core can provide strengthening benefits and by making the flow passage for the ceramic slurry larger enabling superior flow characteristics and a better formed ceramic core. A technical effect of this is that some of the cavity forming members can have smaller sections or other finer features which are difficult to mould which, in turn, provides many synergistic benefits for a component.

The second member may be a cavity forming member. The cavity forming member may be intended for providing a core passage within a fluid cooled component such as a gas turbine aerofoil. The fluid may be air. The gas turbine component may be a blade, a vane or a seal segment.

Either or both of the first and second members may be for providing cooling passages in a cast fluid cooled component. The removable web may be a plate-like member.

The plate-like member may have a thickness in the range of approximately 0.1 mm to 2 mm.

The removable webs may have a thickness in the region of around 0.8 to 1.5 mm. The removable webs may be specified as a ratio of the associated strut thickness. The removable web thickness may be approximately between 0.1 and 1 of the strut thickness. The ratio may be somewhere between 0.3 and 0.5.

The removable web may extend between three or more members. Two or more of the members may be cooling passage forming members. One of the members may be a stock for holding the core within a mould. The stock may or may not be a cavity forming member. The stock may be known as a print. The print may be a tip print. The mould may be a mould for surrounding the ceramic core with a sacrificial material for an investment casting process.

The cooling passage member may be a multi-pass cooling passage. The multi-pass cooling passage may include a plurality of serially connected elongate sections. Each of the sections may extend in a spanwise direction. The serial connection may be provided by a u-bend portion.

The removable web may extend across a corner region which is formed by a junction of the first and second members.

At least one of the members may be a strut which extends between two other members, the strut having a smaller transverse section than the other of the members. There may be a plurality of struts. There may be between two and five struts. The strut may extend between a stock and a cooling passage member of the ceramic core.

The removable web may extend substantially perpendicularly from a surface of one or more of the members.

The removable web may be polygonal when viewed front on. The front on view may correspond to a broadside view of the core. The broadside of the core may correspond to the pressure or suction surface of an aerofoil, or a gas path facing side of a seal segment. The removable web may be rectangular or triangular. The removable web may be generally polygonal and include sides having some filleted corners or small perturbations.

The first member provides an inlet passage in the hub region of a gas turbine blade.

A plurality of removable webs may extend from a common member. The common member may be any of the first, second, third or other members.

The plurality of removable webs may be diametrically opposed.

Also described below is a gas turbine component which may be made using the ceramic core. And a core production facility having a first plurality of ceramic cores which include the removable web; and a second plurality of cores which is the same as the first plurality of cores but with the removable web removed.

A method of forming a ceramic core for an investment casting process may comprise: providing the described ceramic core; and, removing the removable web from the ceramic core.

The ceramic core with the removable web removed is used in an investment casting process.

Within the scope of this application it is expressly envisaged that the various aspects, embodiments, examples and alternatives, and in particular the individual features thereof, set out in the preceding paragraphs, in the claims and/or in the following description and drawings, may be taken independently or in any combination. For example features described in connection with one embodiment are applicable to all embodiments, unless such features are incompatible.

### BRIEF DESCRIPTION OF DRAWINGS

Embodiments of the present disclosure will now be described with the aid of the following drawings of which:

FIG. 1 shows a longitudinal section of a conventional gas turbine engine.

FIG. 2 shows a partial perspective view of a turbine stage of a conventional gas turbine engine.

FIG. 3 shows the steps of a conventional investment casting process.

FIGS. 4a and 4b show perspective views of a conventional gas turbine blade, FIG. 4a being a cut away to reveal some exemplary cooling flow passages.

FIG. 5 shows a conventional generic ceramic core typically used to cast a turbine blade.

FIG. 6 shows a ceramic core according to the present disclosure.

FIG. 7 shows planform section A-A of the strut and web region of the ceramic core shown in FIG. 6.

FIG. 8 shows a flow diagram indicating the steps for manufacturing a core of the present disclosure.

FIG. 9 shows a production facility in which the removable core may be removed.

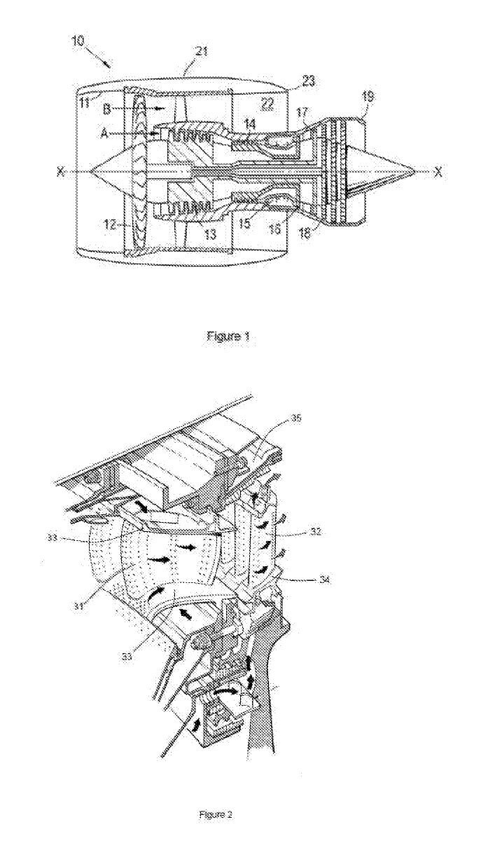

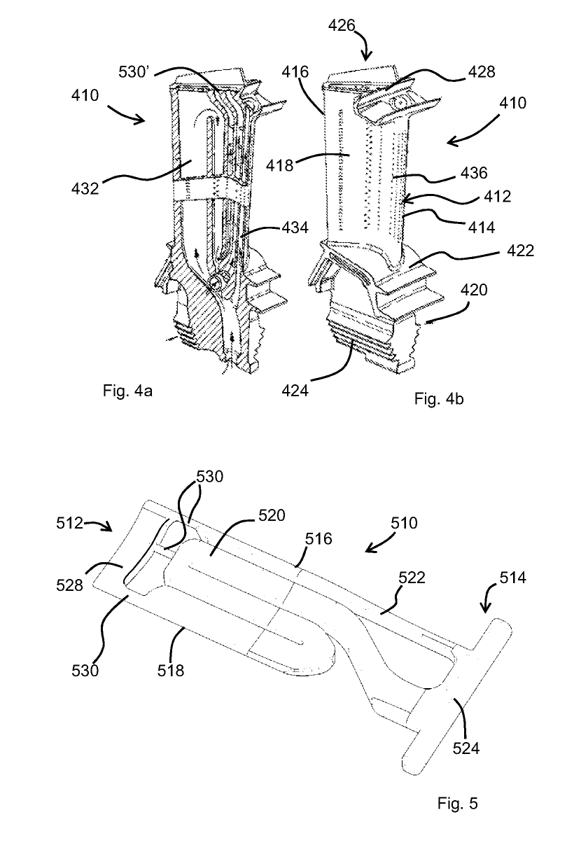

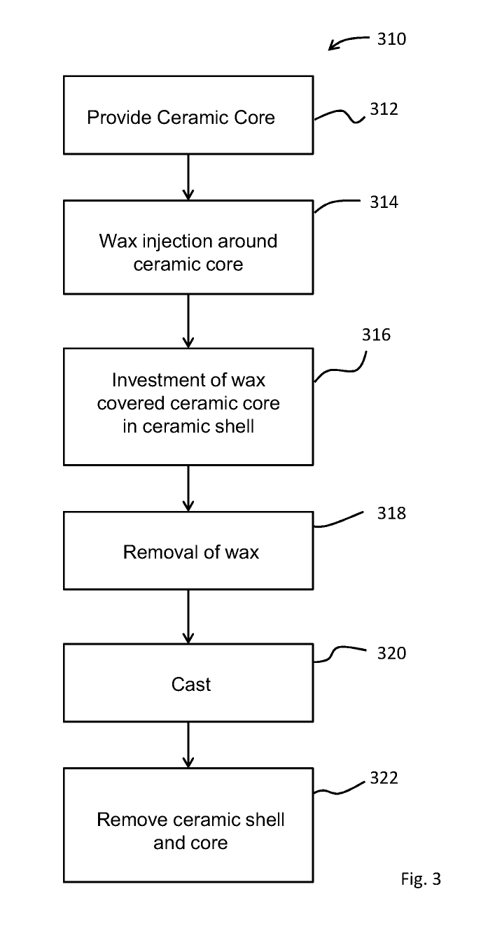

### DETAILED DESCRIPTION OF DRAWINGS

FIG. 4 shows a known turbine blade 410 notionally similar to the one depicted in FIG. 2. The blade 410 includes an aerofoil portion 412 having leading 414 and trailing 416 edges with pressure 418 and suction (obscured from view) surface walls extending therebetween.

The aerofoil portion 412 extends from a hub 420 which includes a platform 422 and attachment fixture in the form of a so-called fir tree root 424. The aerofoil 412 extends in span between the hub platform 422 and a tip 426 which includes a shroud 428. The platform 422 and shroud 428 extend laterally from the aerofoil to having leading and trailing edges and lateral or circumferential edges which face corresponding faces of adjacent components in the rotor array to provide radially inner and radially outer segmented annuli. The radially inner platform and radially outer shroud define the main gas path of the turbine blade.

The partial cutaway shown in FIG. 4a reveals the internal cooling passages which extend from an inlet located in the root 424 of the blade 410. The passages include so-called multi-pass 432 or serpentine type which include multiple serially connected spanwise passages, and single spanwise passages 434. The position and size of the cooling passages are determined by the required cooling duty and will be part specific. There may be any combination of either or both single or multi-pass cooling passages which may extend spanwise or chordwise. There may be multiple passages across the thickness of the aerofoils such that the suction and pressure surfaces have different cooling passage distributions. The multi-pass passages may meander aft rather than fore towards the leading edge. It will be appreciated that other arrangements will be possible.

The cooling passages are exhausted at various locations, some or all of which providing external cooling to the surface of the component. In the example shown, the cooling passages include distributions of film cooling holes 436 on the flanks of the aerofoil including spanwise arrays along the leading edge, the pressure surface mid-chord and local to the trailing edge. Suction surfaces tend to have a reduced number of film cooling holes due to the reduced thermal loading. The tip of the blade also includes cooling holes which are provided at the terminal end of the multi-pass and single pass cooling passages.

As described above, the cooling passages are formed within the body of the blade when the component is cast using a ceramic core.

A multi-pass ceramic core is shown in FIG. 5. The core does not correspond to the cooling passages of the blade shown in FIG. 4a, but is notionally similar to the core which would have been used.

The core 510 includes a tip 512, a root 514, a leading edge portion 516 and a trailing edge portion 518 which relate to the orientation of core as it would be presented in the cast component. The dimension between the tip 512 and root 514 is referred to as the span of the core 510, with the chord denoting the dimension between the leading 516 and trailing 518 edge portions.

The core 510 includes a multi-pass core passage member 520 which includes a plurality, i.e. three in the present case, of serially connected spanwise longitudinal members which are connected by u-bends to provide a meandering or serpentine multi-pass cooling passage member. There is also a single spanwise longitudinal core passage member 522 which extends between the tip 512 and root 514. The single core passage member is located at the leading edge portion 516 of the core 510, with the multi-pass passage 520 member being aft thereof and extending meandrously towards the trailing edge 518 from a mid-chord position. The passage members are connected to a spar 524 which is located at the root 514 of the core 510. In the example shown, there are two connections to the spar, each attributed to one of the core passage members. The core passage members are sized according to the required flow for the resultant passage within the cast component. The root of the core provides the inlet holes for the core passages in the cast component.

The tip of the core is provided with a stock 528 (commonly referred to as a print or tip print) which is used: to hold the core 510 within the mould used to apply the sacrificial moulding as described above; to hold the composite core within the shell mould; and, to provide support for the individual cooling passages. The stock is typically outside of the cast part but it may form a cavity or hollow in the tip of an aerofoil in some instances. A plurality of struts 530 extend from the stock 528 from a first end to a second end which is integrally connected to the core passage members. The struts 530 are elongate members which are separate from each other and provide a through-passage in the tip wall of the cast product. Thus, in the example of a turbine blade such as that shown in FIG. 4a, the struts 530 provide openings may be sealed and bored to provide cooling holes 530′ of the appropriate size in the tip shroud. As such, the stock does not form part of the cast product in this example. However, there may be instances where the stock or an equivalent feature at the tip of the core does form part of the cast product.

A difficulty with the strutted core design shown in FIG. 5 is the permitted thickness required of the struts 530. The struts 530 must be manufactured to have a thickness sufficient to allow the core forming processes to be successfully carried out. Thin struts are difficult to reliably fill with ceramic slurry during the injection process, particularly with higher viscosity ceramics. Even when the strut volumes are fully occupied, weaknesses can occur where two slurry flows meet and fail to knit properly due to localised temperature fluctuations. Additionally, corner portions of the multi-pass core passage members tend to resist core shrinkage and the resultant tensile stresses can lead to a mechanical weakening and failure of the cores post firing. Other causes of failure in the tip region may occur.

Providing a larger sectioned strut can overcome these difficulties, however, too large a strut is also problematic as the holes left by the struts may need to be reduced or entirely closed and the closing process, such as welding which is typically used to do this, may result in distortion of the component which needs to be compensated for in the thickness of the component walls.

The issues with struts limit the geometry of a ceramic core so as to have fewer passages and/or fewer thick to thin transitions or generally simpler designs without, for example, some of the desirable surface features such as turbulator strips. The issues can also affect the material type and strength which can be used for injecting the ceramic cores.

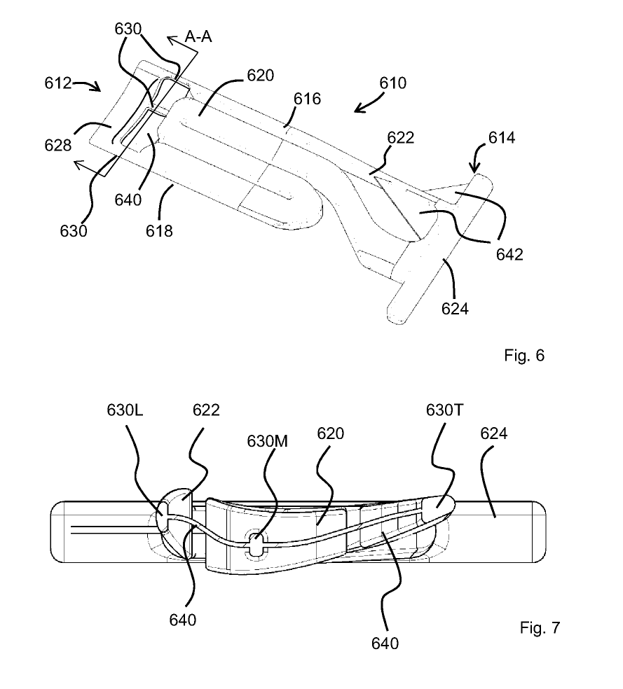

FIG. 6 shows a core 610 to according to an embodiment of the present disclosure. The core 610 is shown from a front facing perspective view which corresponds to the pressure surface of the aerofoil. The core 610 is similar to that described in FIG. 5 and thus includes a tip 612, a root 614, a leading edge portion 616 and a trailing edge portion 618 which relate to the orientation of core as it would be presented in the cast component. The dimension between the tip 612 and root 614 is referred to as the span of the core 610, with the chord denoting the dimension between the leading 616 and trailing 618 edge portions.

The core 610 includes a plurality of structural members in the form of cooling passage members 620, a stock 628, a spar 624 and struts 630 which are reduced section members which bridge between two of the other structural members. The spar 624 is a structural member which connects two of the cooling passage members directly and which may itself be a cooling passage member in the form of an inlet.

The core 610 may include one or more multi-pass core passage members 620 which include a plurality, i.e. three in the present case, of serially connected spanwise longitudinal members which are connected by u-bends to provide a meandering or serpentine multi-pass cooling passage member. There is also a single spanwise longitudinal core passage member 622 which extends between the tip 612 and root 614. The single core passage member is located at the leading edge portion 616 of the core 610, with the multi-pass passage 620 member being aft thereof and extending meandrously towards the trailing edge 618 from a mid-chord position. The core passage members have a thickness in the dimension which extends between the suction and pressure walls and an axial chord length which extends between the leading and trailing edges.

The passage members connected to a spar 624 which is located at the root 614 of the core 610. In the example shown, there are two connections to the spar, each attributed to one of the core passage members. The core passage members are sized according to the required flow for the resultant passage within the cast component. The root of the core provides the inlet holes for the core passages in the cast component.

The tip of the core is provided with a stock 628 which is used to hold the core 610 within the mould used to apply the sacrificial moulding as described above. A plurality of struts 630 extend between the stock 628 and the core passage members.

The struts 630 are elongate members which may be straight and may have a substantially constant cross section along their length. There are three struts shown in FIG. 6, each extending from tip end of one of the core passage members 620, 622. There is a trailing edge strut 630T, a leading edge strut 630L and a mid-chord strut 630M. It will be appreciated that there may be greater or fewer struts than is shown in FIG. 6. The struts have a first end and a second end which are each connected, either directly or via a transition portion, to a face of the stock and the core passage respectively. Each core passage return or terminal end in the tip region includes a strut. The struts may be provided to provide structural rigidity to the ceramic core so that it can withstand the subsequent process steps such as the injection of the sacrificial material. Thus, any free end or cantilevered end of a member or members may be attached to a strut to tie it to an another structural element to provide rigidity and additional strength.

The struts 630 are notable as having a considerably smaller sectional area than the core passages in the example shown and may be defined by a sharp reduction in the sectional area of the core passage or other structural member to provide the thinner section. The transition between the core passage member 620 and 622 and strut 630 may be an abrupt one in which the strut 630 abuts a face of the core passage as per the mid chord strut, or may be tapered as per the leading edge strut 630L where the sectional area of the cross passage member decreases gradually as it morphs into the strut.

As shown in FIG. 7, the struts 630 may be positioned along the camber line of the core which generally corresponds to the camber line of the aerofoil. The struts may be substantially polygonal in planform section with heavily filleted, i.e. rounded, longitudinal edges. The struts 630 may be longitudinally straight or curved.

The core of FIGS. 6 and 7 includes a plurality of removable webs 640 which span between respective struts 630. The web 640 is a plate-like member of ceramic material which extends in span and chord between the struts 630 and has a thickness which extends between the pressure and suction surface sides of the core 610. The thickness of webs 640 is significantly less than that of the struts 630, cooling passage members 620, 622, stock 628 or other structural members to which it may attach. The removable webs 640 may have a thickness in the range between 0.1 mm to 2 mm but will typically be in the region of around 0.8 to 1.5 mm. The removable webs may be specified as a ratio of the associated strut thickness so, for example, may be approximately between 0.1 and 1 of the strut thickness but will typically be somewhere between 0.3 and 0.5. It will be appreciated that the thicknesses of the individual struts and removable webs may vary in themselves and also relative to each other. The webs 640 are removable in that they do not form part of the core which is used in the subsequent investment casting, but are provided to the benefit of producing the core.

The webs 640 are formed with the ceramic core during the injection process (or alternative core forming method). Thus, the webs 640 are made from the same material as the rest of the core 610, are integrally formed therewith and undergo the same manufacturing process until they are removed, typically after firing. The inclusive processing steps may therefore include moulding, solidification and firing of the core. It will be appreciated that other processes may also be shared and the removable web may be removed prior to firing the core. Further, the core may be made using an additive layer procedure.

The web 640 may extend along the length of the struts 630 or other structural member. The webs 640 may extend between the structural members along a curved path. In the present case, this provides the web 640 with a curved profile in the planform section. The joint between the structural member and web 640 may be at the approximate lateral mid-portion of the structural member in section as shown in the planform section of FIG. 7.

The web 640 may extend perpendicularly from the adjoining face. Providing a perpendicular transition between the web and adjoining face of the strut or other portion or member of the core may help reduce stresses in the joint. The web may begin to curve after the perpendicular transition.

The web 640 may extend fully between the struts 630 in chord and may be completely continuous so as not to include any breaks, notches or apertures. The webs 640 may also extend in span from the tip face of the core passage members and the radial inner edge or face of the stock, thus providing a closed web which is attached, at least partially, on all sides.

In the alternative, the webs 640 may include geometric features such as local thickening or reducing features such as notches or apertures or the like where the design permits. The removable webs may be partial and may not extend full width between the first and second members. The plate-like shape of the webs may be, for example, hour glass or bow tie shaped. The webs may be take the form of a strip which extends along the struts. The strip may extend around multiple members to provide a peripheral support with a central aperture. The web may be attached on two or more sides. The web may be attached on three sides or four sides. The majority of the perimeter of the removable web may be joined with a structural member of the ceramic core. One or more of the struts may have a web extending from opposing sides thereof. The webs may be diametrically opposing.

The provision of a web increases the flow section for the ceramic slurry upon injection or pouring, increases the structural strength and rigidity of the area and features local to the web.

It will be appreciated that the webs are extraneous features of the core with a functionality limited to the formation of the core. Hence, once the core has been prepared, the webs are removed using a suitable technique. Such a technique may include manual removal and dressing of the adjoining portions by hand, or may include machining of the ceramic where possible. Such machining may include CNC machining.

A further application of the webs 642 is shown at the hub end of the core 610. In this example, the web 642 is provided between a cooling passage member 622 and the spar 624. It will be appreciated that the removable webs 640 are not restricted to the tip or hubs and may be employed anywhere on the core 610.

The cooling passage member 622 may extend from a face of the spar at an angle. The angle may be approximately ninety degrees as shown, or any which can benefit from the advantages provided by a webbed support. The web 642 spans between the spar surface and cooling passage member to brace the corner region where the two components meet. The corner web may be triangular or some other three sided shape. For example, the hypotenuse of the web 642 may be curved or include multiple facets.

In the example shown, the there are two webs which are on opposing sides of an elongate member which extends at an angle from a cross piece.

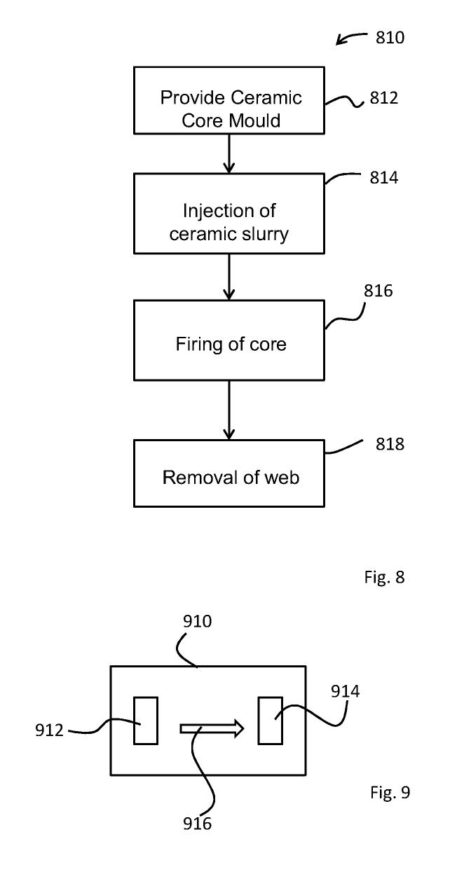

FIG. 8 shows a method for manufacturing the ceramic core 810 according to the present disclosure. The first step is to provide a mould 812 for receiving a ceramic slurry for producing the core. The ceramic slurry will typically comprise ceramic particulates and a binder material as is well known in the art. The mould is shaped to provide the core required for an investment cast component such as the aerofoil described above. Hence, the core includes at least a first member, a second member and a removable web which spans between the first and second member.

The ceramic is introduced into the mould by injection 814 or pouring before being solidified and fired 816. Once fired the web can be removed 818 using a suitable process. The removal process may be via a machine such as a CNC milling machine which uses a rotating tool to cut the removable web out. Alternatively, or additionally, the web may be removed by hand using appropriate tools.

FIG. 9 shows a schematic representation of a production facility 910 which may be used to remove the removable web. The production facility may be any suitable facility which is capable of removing the webs. Thus, the cores may be manufactured in a facility having a process line in which there are a plurality of first cores 912 and plurality of second cores 914 which are differentiated at least by the presence or absence of the removable web. Thus, the first cores may include the removable web and the second cores may be the same as the first cores but with the web removed. The production facility may or may not produce the ceramic cores and may or may not perform the remaining steps of the core forming or investment casting process. For example, the cores may be made and fired at a first location before being imported into the facility for the removal of the web and inclusion in a composite core or other part of an investment casting process. The facility will also include some form of web removing capability 916 which may be mechanised or manual.

Although the above described embodiment relates to a blade for a gas turbine engine, it will be appreciated that a similar core could be used for any hollow cast member. In the case of a gas turbine, this may include a nozzle guide vane for a turbine or a compressor for example. It is contemplated that other components may be cast using the above described web. Thus, generally, the removable web may be deployed between any two structural members in any ceramic core. Thus, there may be a first member and a second member having a removable web extending therebetween. The first and second members may be adjacent or opposite one another in the sense that they may directly connect with one another so as to be adjacent, or be separate from or connected indirectly via a third member so as to be opposite one another. In this context, opposite may or may not include the first and second members facing one another.

The first and second members, and third where the case may be, will generally be thicker than the web which will be plate-like in most instances.

The components described above generally relate to air cooled components. It will be appreciated that the cooling may be achieved by other fluids such as steam.

It will be understood that the invention is not limited to the described examples and embodiments and various modifications and improvements can be made without departing from the concepts described herein and the scope of the claims. Except where mutually exclusive, any of the features may be employed separately or in combination with any other features in the disclosure extends to and includes all combinations and sub-combinations of one or more described features.

1. A ceramic core for producing cast component for a gas turbine engine, the core comprising:
a first cavity forming member;
a second member adjacent to or opposite the first cavity forming member;
and a removable web which joins the first and second members, wherein the removable web is plate-like member having a thickness in the range of approximately 0.1 mm to approximately 2 mm.

2. A ceramic core as claimed in claim 1, wherein the second member is a cavity forming member.

3. A ceramic core as claimed in claim 1, wherein either or both of the first and second members are for providing a cooling passage member in a cast fluid cooled component.

4. A ceramic core as claimed in claim 1, wherein the removable web extends between three or more members.

5. A ceramic core as claimed in claim 1, wherein at least one of the members is a stock for holding the core within a mould.

6. A ceramic core as claimed in claim 3, wherein cooling passage member of the first or second member is a multi-pass cooling passage.

7. A ceramic core as claimed in claim 1, wherein the removable web extends across a corner region which is formed by a junction of the first and second members.

8. A ceramic core as claimed in claim 1, wherein at least one of the members is a strut which extends between two other members, the strut having a smaller transverse section than the other of the members.

9. A ceramic core as claimed in claim 1, wherein the removable web extends substantially perpendicularly from a surface of one or more of the members.

10. A ceramic core as claimed in claim 1, wherein the removable web is polygonal when viewed in the direction normal to a surface of the plate-like member.

11. A ceramic core as claimed in claim 1, wherein the first member provides an inlet passage in a hub region of a gas turbine blade.

12. A ceramic core as claimed in claim 1, wherein a plurality of removable webs extend from a common member.

13. A ceramic core as claimed in claim 12, wherein the plurality of removable webs are diametrically opposed about the common member.

14. A gas turbine component made using the ceramic core of claim 1.

15. A core production facility having a first plurality of ceramic cores according to claim 1, and a second plurality of cores which is the same as the first plurality of cores but with the removable web removed.

16. A method of forming a ceramic core for an investment casting process comprising:
providing a ceramic core comprising:
a first cavity forming member;
a second member adjacent to or opposite the first cavity forming member;
and a removable web which joins the first and second members, wherein the removable web is plate-like member having a thickness in the range of approximately 0.1 mm to approximately 2 mm; and
removing the removable web prior to the ceramic core being used in a casting process for a gas turbine component.
